(19) United States
(12) Patent Application Publication
(10) Pub. No.: US 2025/0104081 A1
(43) Pub. Date: Mar. 27, 2025

(54) SYSTEM, DEVICE AND METHOD FOR DIGITAL PAYMENT

(71) Applicant: NAYAX LTD., Herzliya (IL)

(72) Inventors: David BEN-AVI, Herzliya (IL); Guy ROSENHOIZ, Herzliya (IL)

(21) Appl. No.: 18/729,820

(22) PCT Filed: Mar. 20, 2023
(86) PCT No.: PCT/IL2023/050290

§ 371 Date: Jul. 17, 2024

(30) Foreign Application Priority Data
Apr. 14, 2022 (IL) 292283

(51) Int. Cl. G06Q 20/40; G06Q 20/22; G06Q 20/38

(52) U.S. Cl. CPC G06Q 20/403; G06Q 20/29; G06Q 20/389

(57) ABSTRACT

A payment server for a user transaction approval configured to receive from the two or more trusted entities two or more sets of rules for the user transaction approval, receive from the payment terminal a transaction approval request, a token, payment terminal data, and additional data obtained by the payment terminal, receive from the at least one payment account a balance limitation decision and generate a transaction approval decision by cross-referencing the two or more sets of rules with the mobile device data, the payment terminal data, the additional data, and the balance limitation decision.

### TECHNICAL FIELD

Some embodiments described herein generally relate to a payment system and method, more specifically to digital payments over a digital network.

### BACKGROUND

A digital payment system may enable purchases in virtual stores over the Internet. Those systems may use the user's credit card or other payment methods such as, for example, Pay Pal, crypto coins, or the like to pay for the merchandise.

However, payments cards of bodies such as, for example, loyalty clubs, enable members of the loyalty club to purchase goods and services only with loyalty club points and/or coupons, and only in stores available for the loyalty club members, e.g., stores that accepted their loyalty club card. The loyalty card may issue a global set of rules for all of its members. The global set of rules enables members of the loyalty club to purchase goods and services according to the loyalty club rules.

Thus, there is a need to provide to members of, for example, loyalty clubs, a flexible ability to purchase goods and services.

### SUMMARY

Embodiments related to a payment server and a method for purchasing goods and services are described hereinbelow by the way of example only.

One embodiment may include a payment server for a user transaction approval in communication with two or more trusted entities, at least one payment account associated with a trusted entity of the two or more trusted entities, a payment terminal and a mobile device, wherein the payment server is configured to: receive from the two or more trusted entities two or more sets of rules for the user transaction approval; receive from the payment terminal a transaction approval request along with a token, payment terminal data, and additional data obtained by the payment terminal; receive from the at least one payment account an available balance and generate a balance limitation decision being selected from: an approval, a partial approval, and a decline of the transaction approval request based on the available balance; send a request for mobile device data from the mobile device and receive the mobile device data; generate a transaction approval decision by cross-referencing the two or more sets of rules with the mobile device data, the payment terminal data, the additional data, and the balance limitation decision.

For example, the mobile device data comprise a history log which is configured to store historical events data recorded by the mobile device.

For example, the mobile device data may further comprise data obtained in a real-time from at least one of a plurality of input elements which are operably coupled to the mobile device, wherein the plurality of the input elements comprise: a camera, a microphone, a touchscreen, an internal movement sensors, a scent sensor, a fingerprint reader and a global positioning system (GPS) receiver.

For example, the additional data obtained by the payment terminal comprise a product identification (ID) in relation to which the transaction is to be performed.

The payment server of claim 1, wherein the trusted entity of the two or more trusted entities is configured to receive an indication on activation of a rule of the two or more rules.

For example, the payment server may be configured to report to the mobile device that the request for payment is declined based on an activation of a rule of the one or more sets of rules.

For example, the activation of a rule of the sets of rules triggers the activation of another rule.

For example, the token is not associated with a physical payment card.

For example, the token comprises user data arranged according to a Europay, Visa, Mastercard (EVM) standard.

For example, the token is a one-time use token and uploaded with a zero amount of benefits.

For example, the token is embedded in a software development kit (SDK) of a digital wallet application, and the payment terminal is configured to receive data of the digital payment token from a mobile device that comprises the SDK.

For example, the SDK comprises the digital wallet application.

For example, the trusted entity is an entity that is verified by the payment server according to the set of rules and marked as trusted.

For example, the two or more set of rules comprises: a first set of rules provided by the payment server; a second set of rules provided by a business group; a third set of rules provided by a payment token issuer; and a fourth set of rules provided by the client of the business group.

Another embodiment may include a method for the approval of the user transaction by the payment server comprises the following stages at stage 1 check whether the transaction approval request is in a condition to be approved or partially approved for payment from a selected payment account of the one or more payments accounts in accordance with two or more rules of the trusted entity of the two or more trusted entities associated with the selected payment account and a balance limitation decision for the selected payment account; if the transaction approval request is approved the method proceeds to stage 2; if the transaction approval request is declined the method proceeds to stage 3; if the transaction approval request is partially approved, set a payable amount by the selected payment account as pending approval subject to an approval of a remaining amount for payment by another payment account or payment accounts selected payment account from the two or more payment accounts, and proceed to stage 3 in respect to the remaining amount; at stage 2 perform a transaction in the amount of the transaction approval request via the payment terminal with the selected payment account or multiple selected payment accounts of the one or more payment accounts; at stage 3 check whether an alternative payment account is available; if yes proceed to stage 4 and if no proceed to stage 5; at stage 4 set the alternative payment account as the selected payment account for paying the full amount or the remaining amount of the transaction approval request, and proceed to stage 1 in respect to the approval off the full amount or the remaining amount of the transaction approval request; and at stage 5, if the payment request in stage 3 is declined by all of said at least one other payment account, decline the transaction via the payment terminal.

Another another embodiment may include a method for the approval of the user transaction by the payment server comprising checking whether the transaction approval request is in a condition to be approved or partially approved for payment from a selected payment account of the one or more payments accounts based on the two or more rules of the trusted entity of the two or more trusted entities associated with the selected payment account and a balance limitation decision for the selected payment account; performing a transaction of a requested payment amount via the payment terminal to the selected payment account of the one or more payment accounts; and setting the alternative payment account as the selected payment account for paying the requested payment amount or a partial payment amount of the remaining payment amount of the requested payment amount and repeating the checking, the performing and the setting with respect to the approval of the requested payment amount or the partially remaining payment amount of the two or more trusted entities.

For example, when checking whether the transaction approval request is in a condition to be approved or partially approved for payment from the selected payment account of the one or more payment accounts is failed, and the payment request is declined, setting the alternative payment account as the selected payment account.

For example, when the payment request is partially approved, the method is configured to set the payable amount by the selected payment account as pending to approval, subject to approval of a remaining amount for payment by another account selected from the two or more payment accounts and setting the alternative payment account as the selected payment account for paying for the remaining amount for payment.

For example, when the alternative payment account is available for payment, setting the alternative payment account as the selected payment account for paying the requested amount or a partial amount of the remaining amount of the payment request.

For example, when the alternative payment account is not available for payment, decline the transaction via the payment terminal.

For example, the method comprises: declining the transaction via the payment terminal when the payment request is declined by all of said at least one other payment account.

It is understood from the present disclosure to describe a solution for shortcomings in the field of art. More specifically, the embodiments described herein enable performing payments by members of the loyalty club by using a disposable payment element.

### BRIEF DESCRIPTION OF THE DRAWING

FIG. 1 illustrates a block diagram of a system for performing payments over a network according to some demonstrative embodiments.

FIG. 2 illustrates a flow chart of a method for purchasing goods and services using a digital payment token, according to some demonstrative embodiments.

FIG. 3 illustrates a block diagram of a dynamic set of rules system, according to some demonstrative embodiments.

FIG. 4 illustrates a block diagram of a dynamic set of rules system, according to some other demonstrative embodiments.

FIG. 5 illustrates a product of manufacture, according to some demonstrative embodiments.

FIG. 6 illustrates another embodiment of payment system, according to some other demonstrative embodiments.

FIG. 7 illustrates a payment system with a rule generator and sensors configured to be controlled by a rule to interact with a user, according to some other demonstrative embodiments.

FIG. 8 illustrates a payment system and a flow chart of a method for payment, according to some other demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to one or more processors, e.g., as necessary to execute the logic.

The term “module,” as used hereinbelow, is an object file that contains code to extend the running kernel environment.

The term “EMV,” as used hereinbelow, is a payment method based upon a technical standard for smart payment cards and for payment terminals and automated teller machines. EMV originally stood for “Europay, Mastercard, and Visa,” the three companies which created the global payment standard.

The term “EMV terminal,” as used hereinbelow, is a payment terminal also known as a Point of Sale (POS) terminal, credit card terminal, etc. The EMV terminal is a device that interfaces with payment cards, e.g., Europay, Mastercard, Visa, to make electronic funds transfers. The terminal typically consists of a secure keypad for entering a PIN, a screen, a means of capturing information from payments cards, and a network connection to access the payment network for authorization.

In some demonstrative embodiments, the payment terminal may allow a merchant to capture required credit and/or debit card information and transmit this data to the merchant services provider and/or bank for authorization and transfer funds to the merchant. The terminal may allow the merchant and/or their client to swipe, insert and/or hold a card near the device to capture the information.

The term “Issuer Module,” as used hereinbelow, may include, for example, the Mastercard, Visa, EuroPay, American Express, etc., software configured to issue a payment token. The payment token may be configured to fulfill a function of a payment card, e.g., credit cards, debit cards, charge cards, and the like.

The term “Card/s,” as used hereinbelow, may include, for example, the prepaid card created and issued by an issuer, credit cards, debit cards, or the like.

The term “mobile application,” as used hereinbelow, may include at least one application which is installed on the mobile device, for example, the loyalty club application, e-Wallet application, or the like. The mobile application may include the digital wallet SDK and may interact with the digital wallet platform and the customer platform. The customer mobile application may be configured to run on a mobile device operating system, such as, for example, iOS and Android or React.

The term “Payment token,” as used hereinbelow, may include a unique placeholder called a payment token which is configured to include encrypted information of a payment ability of the user, for example, a credit card, a debit card, a prepaid card, a reloadable prepaid card, bank money transfer information, or the like. In some demonstrative embodiment, the payment token may be configured to access, retrieve, and maintain, for example, a customer's credit card information to ensure a higher level of security for both the customer and the business. The payment token may be saved on the customer platform and/or on the customer's mobile application.

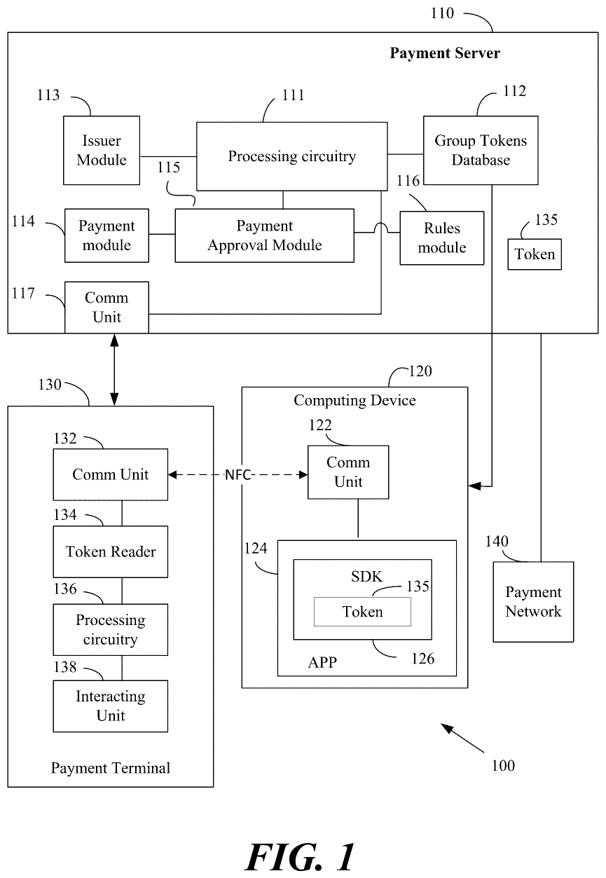

Reference is made first to FIG. 1, which is an illustration of a block diagram of a system 100 for executing payments according to some demonstrative embodiments.

In some demonstrative embodiments, system 100 may include a payment server 110, a computing device 120, a payment terminal 130 and a payment server 140. For example, payment server 110 may include processing circuitry 111, a group tokens database 112, an issuer module 113, a payment approval module 115, and a rules module 116.

In some demonstrative embodiments, processing circuitry 111 may include circuits, logic, memory, an operating system, one or more cores computer, a graphic processor, a digital signal processor, or the like.

In some demonstrative embodiments, payment server 110 may include one or more group token databases 112. The one or more group tokens database 112 may include and\or store one or more tokens of one or more business groups. For example. and a group tokens database of the one or more group tokens databases 112 may include one or more payment tokens of one or more clients, respectively, e.g., a payment token 135. For example, the business group may include loyalty clubs, companies, organizations, and the like.

In some demonstrative embodiments, the digital payment token 135 may include user data arranged according to a Europay, Visa, Mastercard (EVM) standard. The digital payment token 135 may also be referred as a digital EVM token.

In some demonstrative embodiments, the digital payment token 135 may be uploaded with a zero number of benefits.

In some demonstrative embodiments, the digital payment token 135 may be a one-time-use token. For example, the digital payment token may be used for one purchase.

In some other demonstrative embodiments, a lifetime of the digital payment token 135 may be limited to a predetermined time. For example, the digital payment token may be used for one month only and/or for a predetermined number of purchases and the like.

In some demonstrative embodiments, the issuer module 113 may be configured to issue the digital payment token 135 for each client. For example, the issuer module 113 may issue the digital payment token 135 with data according to the EMV standard.

In some demonstrative embodiments, the payment module 114 may be configured to transfer the requested amount of benefit to a merchant account, to update the business group account and the client account.

In some demonstrative embodiments, the benefits may include loyalty club points, loyalty club coupons, any amount of money and/or credit, cryptographic coins, and any other available payment currencies.

In some demonstrative embodiments, a rules module 116 may be configured to store one or more dynamic set of rules. For example, the dynamic set of rules may include a first set of rules provided by the payment server, a second set of rules is provided by a client of the payment server, a third set of rules is provided by a payment cards server; and a fourth set of rules is provided by the user.

In some demonstrative embodiments, a rule of the dynamic set of rules may include a Boolean script that is configured to be executed by the payment server 110.

In some demonstrative embodiments, a rules module 116 may be configured to store one or more scripts of Boolean rules of different entities, for example, payment server rules, loyalty club rules, personal rules, bank rules, general rules, and the like.

In some demonstrative embodiments, payment approval module 115 may be configured to receive a payment approval request from, for example, the payment terminal 130. The payment approval module 115 may process the request based on one or more sets of rules and the account balance of the payment token holder. The payment approval module 115 may send an approval or denial to payment terminal 130 based on the processing.

Although, it should be understood that in some other embodiments, each of the payment issuer module 113, the payment module 114 the payment approval module 115, and the rules module 116 may be implemented by software and/or hardware and/or by a combination of software and hardware.

In some demonstrative embodiments, processing circuitry 111 may be configured to issue a digital payment token using issuer module 113, for clients and/or members of, for example, a loyalty club, and to store the digital payment tokens, e.g., token 135 at the group tokens database 112.

In some demonstrative embodiments, payment server 110 may be configured to execute payments. For example, a communication unit 117 may be configured to receive a request for payment by a digital payment token, wherein the digital payment token is not associated with a physical payment card. Processing circuity 111 is configured to process the payment request according to a dynamic set of rules, wherein at least some of the rules are generated by a client of the digital payment token.

In some demonstrative embodiments, processing circuity 111 is configured to send approval or denial response to the payment request based on the processing through the communication unit 117.

In some demonstrative embodiments, processing circuitry 111 may be configured to receive an approval request message from payment terminal 130.

In some demonstrative embodiments, the computing device 120 may include an application 124. For example, the application may include a software development kit (SDK) 126 with the digital payment token, e.g., token 135, and a communication unit 122.

In some demonstrative embodiments, the computing device may be, a cell phone, a tablet, a digital wallet device, a smartwatch, a laptop computer and/or any type of computerized personal and/or mobile device.

In some demonstrative embodiments, application 124 may be a digital wallet application programmed with the SDK 126. For example, SDK 126 is specially designed to communicate with payment tokens issued by issuer module 113 of payment server 110. In one implementation, SDK 126 is configured to delete the payment token after it has been used and to request to issue a new payment token to be uploaded to the digital wallet application 124.

In some other embodiments SDK 126 may be embedded in the digital wallet application 124.

In some demonstrative embodiments, communication unit 122 may include, for example, a Near Field Communication (NFC) radio which may enable a secure transaction of the digital payment token to the payment terminal 130.

It should be understood that communication unit 122 may include one or more different types of radios. For example, a cellphone radio, WiFi radio, 60 GHz radio, RF ID, Bluetooth, and the like.

In some demonstrative embodiments, payment terminal 130 may be configured to execute payments. The payment terminal 130 may include a communication unit 132, a token reader 134, processing circuitry 136, and an output unit 138.

In some other embodiments, payment terminal 130 may be referred to as EMV terminal.

In some demonstrative embodiments, communication unit 132 may include, for example, a Near Field Communication (NFC) radio which may enable a secure transaction of the digital payment token to the payment terminal 120.

In some demonstrative embodiments, payment terminal 130 may be configured to execute payments. For example, the payment terminal 130 may include processing circuitry 136. Processing circuitry 136 may be configured to enable token reader 134 to receive a request for payment by the digital payment token 135 transmitted by payment application 124 at mobile device 120.

In some demonstrative embodiments, processing circuitry 136 may enable communication unit 132 to transfer the payer identification data and the payer account data to the payment server 110 for processing the payment request according to a dynamic set of rules. For example, a set of rules of a dynamic set of rules may be generated by a trusted entity. For example, the set of rules may include a plurality of Boolean rules which are validated and provided as a script to payment server 110. Furthermore, the dynamic set of rules may be continuously modified by the set of rules provider, e.g., trusted entity. For example, the trusted entity may be an entity that is verified by the payment server 110 according to the set of rules and, for example, marked as trusted.

In some demonstrative embodiments, payment terminal 130 may receive from the payment server 110 approval and/or denial to the payment request based on the processing the by the payment server 110 based on the dynamic set of rules.

In some demonstrative embodiments, payment terminal 130 may present the approving process at an interacting unit 130, if desired.

It should be understood that communication unit 132 may include one or more different types of radios. For example, a cellphone radio, WiFi radio, 60 GHz radio, RF ID, Bluetooth, and the like.

In some demonstrative embodiments, the communication unit 132 may be configured to transfer the digital payment token data to a payment server 110 for processing the payment request according to a dynamic set of rules, wherein at least some of the rules are generated by a user of the digital payment token, e.g., token 135.

For example, the digital payment token data may include payer identification data and the payer account data.

In some demonstrative embodiments, the communication unit 132 may receive from payment server 110, e.g., payment approval module 115, approval or denial of the payment request based on the processing of the dynamic set of rules.

In some demonstrative embodiments, a token reader 134 may be configured to receive a request for payment by a digital payment token, e.g., token 135, wherein the digital payment is not associated with a physical payment card.

In some demonstrative embodiments, token reader 134 may be implemented by software, hardware, and/or a combination of software and hardware.

In some demonstrative embodiments, the digital payment token may be embedded in SDK 126 of a digital wallet, and the payment terminal 130 may be configured to receive the digital payment token 135 from a mobile device 120 that comprises the SDK 126 by touching the mobile device 120 to the payment terminal 130.

In some demonstrative embodiments, processing circuitry 136 may be configured to run software instructions that may control and/or process data received from the communication unit 132, token reader 134, and interacting unit 138.

In some demonstrative embodiments, processing circuitry 136 may include circuits, logic, memory, an operating system, one or more cores computer, a graphic processor, a digital signal processor, or the like.

In some demonstrative embodiments, an interacting unit 138 may be configured to interact with the digital token holder. For example, interact unit 138 may display the process of approval, issue a receipt, ask to enter a code, and/or share the purchase data with, for example, an email account.

In some demonstrative embodiments, token reader 134 may be implemented by software, hardware, and/or a combination of software and hardware.

In some demonstrative embodiments, the payment server 110 is configured to transfer the payment to the merchant in the event of payment. The payment server 110 is configured to receive payment from the business group a predetermined time for purchases made by one or more clients. For example, once a month, every quarter, when reaching a predetermined amount of credit, or the like.

In some demonstrative embodiments, the payment server 110 may be configured to receive payment from a payment network 140 every predetermined time for purchases made by the one or more clients, for example, payment network 140, may include banks, financial institutes, loyalty clubs, commercial networks, stores and the like.

In some demonstrative embodiments, a payment module 114 may be configured to transfer the requested amount of benefit to a payment network 140 and to update the business group account and a client account.

Advantageously, the present disclosure may provide a system that supports performing purchasing of goods and services digitally without using a physical payment card with benefits granted to the purchaser and controlled by a dynamic set of rules. The dynamic set of rules may grant benefits to the purchaser, may convert the benefits to money, may provide a price limit, may set certain days for purchasing, and the like. Thus, the dynamic set of rules may provide a “smart” buying experience and better use of its benefits and/or money.

Furthermore, the dynamic set of rules may enable the performance of transactions optimized to the business group's monetary policy. For example, a municipality may add a rule that may send a tax report when the transaction is completed. In addition, the dynamic set of rules may include rules that enable business partners of the trusted entity to add rules that block security breaches. For example, a rule that blocks alcohol selling in a territory that is observed as a territory with high alcohol fraud and/or limits alcohol sales to a certain hour of the day.

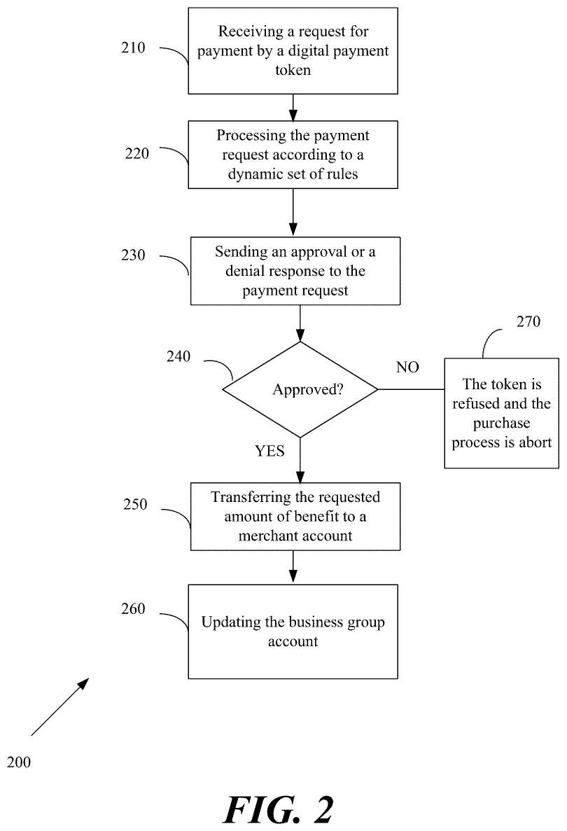

Reference is now made to FIG. 2, which is a schematic illustration of a flow chart of a method 200 for purchasing goods and services using a digital payment token, according to some demonstrative embodiments.

In some demonstrative embodiments, method 200 may operate on a payment server, e.g., payment server 110 (FIG. 1/). Method 200 may start with receiving a request for payment initiated by a digital payment token, e.g., token 135 (FIG. 1) from a payment terminal, e.g., payment terminal 130 of FIG. 1 (text box 210). For example, the digital payment, e.g., token 135 (FIG. 1.) may not be associated with a physical payment card.

Method 200 may proceed with processing the payment requests according to a dynamic set of rules (text box 220). For example, the dynamic set of rules may include, at least one of, a first set of rules provided by the payment server, a second set of rules provided by a business group, a third set of rules provided by a payment cards server, a fourth set of rules provided by a client of the business group and/or at least some of the rules are generated by a user of the digital payment token.

In some demonstrative embodiments, method 200 may proceed with sending an approval or a denial response to the payment request to the payment terminal (text box 230). For example, the approval or the denial may be based on the processing. If the request has been approved (diamond 240), the payment server may transfer the requested amount of benefit to a merchant account (text box 250) and may update the business group account and the client account (text box 260). If the request is not approved (text box 240) the digital payment token is refused, and the purchasing process is aborted (text box 270).

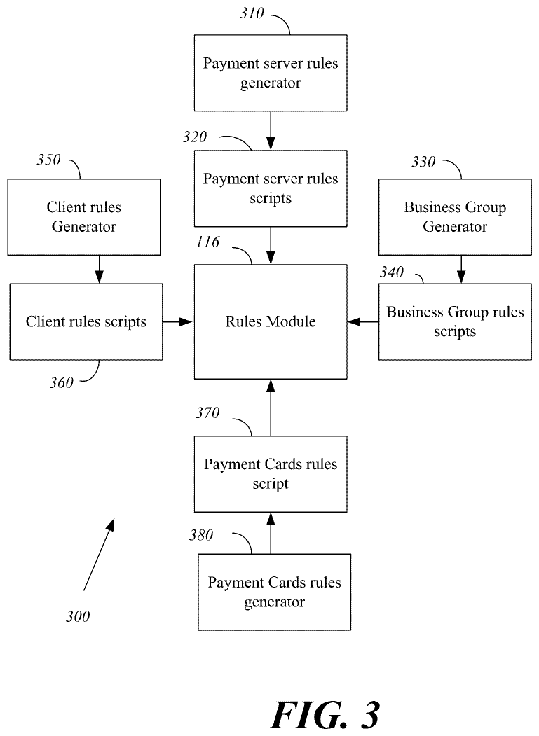

Reference is made to FIG. 3, which is an illustration of a block diagram of a dynamic set of rules system 300, according to some other demonstrative embodiments.

In some demonstrative embodiments, system 300 may be operably coupled to the payment server, e.g., payment server 110 (FIG. 1).

In some demonstrative embodiments, system 300 may include the rules module 116 of FIG. 1. Rules module 116 may be configured to receive plurality rules scrips which may be dynamically generated at different resources.

For example, rules module 116 may be configured to receive payment server rules scripts 320. The payment server rules scripts 320 may be dynamically generated by payment server rules generator 310. For example, the payment server rules generator 310 may be located at the payment server 110. The payment server rules generator 310 may be implemented by hardware or by software or as any combination of hardware and software.

For example, the rules module 116 may be configured to receive business group rules scripts 340. The business group rules scripts 340 may be dynamically generated by business group rules generator 330. For example, the business group rules generator 330 may be located at the payment server 110. The business group rules generator 330 may be implemented by hardware or by software or as any combination of hardware and software.

For example, rules module 116 may be configured to receive client rules scripts 360. The client rules scripts 360 may be dynamically generated by client rules generator 350. For example, the client rules generator 350 may be located at the payment server 110. The client rules generator 350 may be implemented by hardware or by software or as any combination of hardware and software.

For example, rules module 116 may be configured to receive payment cards rules scripts 370. The payment card rules scripts 370 may be dynamically generated by payment card rules generator 380. For example, the payment card rules generator 380 may be located at the payment server 110. The payment card rules generator 380 may be implemented by hardware or by software or as any combination of hardware and software.

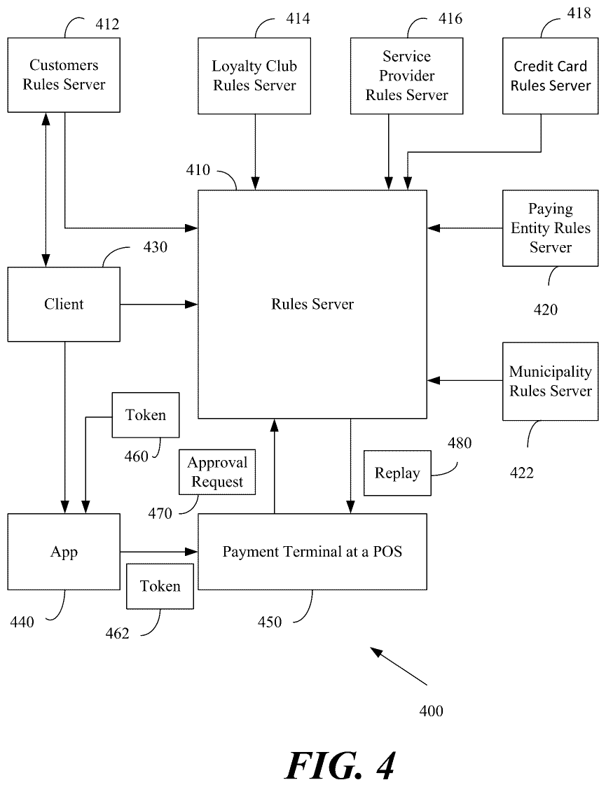

Reference is now made to FIG. 4 illustrates a block diagram of a dynamic set of rules system 400, according to some other demonstrative embodiments.

In some other demonstrative embodiments, system 400 may include a rules server 410. For example, rules server 410 may receive a set of rules from different entities, e.g., trusted entities. For example, the set of rules may be received from a customer rules server 412, a loyalty club rules server 414, a service provider rules server 416, a credit card issuer rules server 418 a paying entity rules server 420, a municipality rules server 422, a client rules 430 and the like.

In operation, a token 460 may be downloaded to an application 440, e.g., a digital wallet application. Client 430 may perform a purchase using the application 440 by transferring a token 462 data and client data to a payment terminal at a Point of Sale (POS) 450. The payment terminal 450 may transfer an approval request 470 to rules server 410. For example, the payment request may include the token 462 data, the store data, the payment terminal data, the type of purchase, the type of goods and/or service, the amount of money to be paid and etc.

In some demonstrative embodiments, the rule server 410 may process the request according to the dynamic set of rules. For example, the rules server may perform a cross-examination to ensure that the token is used only with this specific purchase and not used at the same time in another POS. Based on the cross-examination and other rules the rules server 410 may approve and or refuse the purchase. The rules server 410 may send a replay 480 to payment terminal 450.

In some demonstrative embodiments, the payment terminal may be a payment application embedded on a web page, e.g., POS.

It should be understood that the above is an example only and other rules may be applied.

In some demonstrative embodiments, a trusted entity may be configured to receive an indication on activation of a rule of the dynamic set of rules. For example, client 430 may generate a rule that enables him to buy only one type of product. Client 430 may be reported that an attempt to buy another type of product has been blocked by his rule.

In some demonstrative embodiments, a rule may report to a buyer that the request for payment is refused based on the activation of a rule of the dynamic set of rules. For example, the report may include the reason for the refusal, e.g., the daily limit of purchases has been met. The rules server 410 may send an email and/or a digital message, e.g., text message, SMS, to the buyer.

In some demonstrative embodiments, activation of a rule of the dynamic set of rules by the rules server 410 may trigger activation of another rule. For example, if a payment, e.g., by the digital payment token is refused, for example, passing the credit limit (a bank rule), the rule server 410 may activate another rule, e.g., a rule of a credit card company, which offers a loan to the buyer. Another example, for example, is if a payment, e.g., by the digital payment token is refused. For example, if a payment, e.g., by the digital payment token is refused, for example, the buyer is attempting to buy outside his territory, e.g., a rule of the loyalty club, the rule server 410 may activate another rule, e.g., a rule of the store, that offers the buyer to purchase a similar product in another branch of the store.

In some demonstrative embodiments, for example, a rule for purchasing goods, e.g., a dress, may activate an advertisement for buying accessories, e.g., a belt.

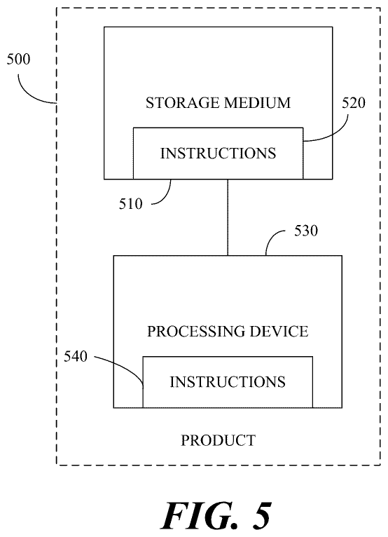

Reference is now made to FIG. 5, which is a schematic illustration of a product of manufacture 500, according to some demonstrative embodiments. Product 500 may include one or more tangible computer-readable non-transitory storage media 510, which may include computer-executable instructions 530, implemented by processing device 520, operable to, when executed by at least one computer processor, enable the at least one processing circuitry 111 (FIG. 1) to implement one or more program instructions for purchasing goods and/or services using a digital payment token based on a dynamic set of rules, and/or to perform, trigger and/or implement one or more operations, communications and/or functionalities as described above with reference to FIGS. 1-3. The phrase “non-transitory machine-readable medium” is directed to include all computer-readable media, with the sole exception being a transitory propagating signal.

In some demonstrative embodiments, product 500 and/or machine-readable storage medium 510 may include one or more types of computer-readable storage media capable of storing data, including volatile memory, non-volatile memory, removable or non-removable memory, erasable or non-erasable memory, writeable or re-writeable memory, and the like. For example, machine-readable storage medium 510 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusion drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 420 may include logic. The logic may include instructions, data, and/or code, which, if executed by a machine, may cause the machine to perform a method, process and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 520 may include or may be implemented as software, firmware, a software module, an application, a program, a subroutine, instructions, an instruction set, computing code, words, values, symbols, and the like. Instructions 440 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled and/or interpreted programming languages, such as C, C++, C#, Java, Python, BASIC, Mat lab, assembly language, machine code, and the like.

It is to be understood that the system and/or the method for performing purchases over a network using a disposable payment element is described hereinabove by way of example only. Other embodiments may be implemented based on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware, and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that, when executed, perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

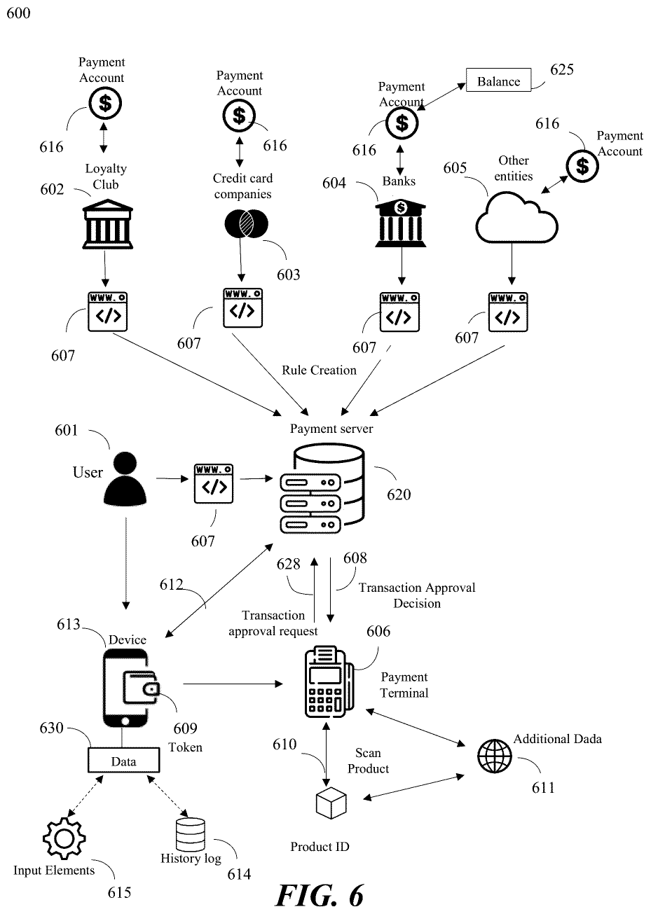

Reference is now made to FIG. 6 which illustrates another embodiment of a payment system 600 according to some demonstrative embodiments.

In sine demonstrative embodiments, system 600 may include a payment server for a user transaction approval 620. Server 620 may be in communication with two or more trusted entities, e.g., trusted entities 602, 603, 604 and/or 605, at least one payment account (616) associated with a trusted entity, e.g., trusted entity 605, of the two or more trusted entities 602, 603, 604 and/or 605, a payment terminal (606) and a mobile device (613).

In some demonstrative embodiments, payment server 620 may be configured to receive from two or more trusted entities 602, 603, 604 and/or 605 two or more sets of rules for the user transaction approval 607. Payment server 620 may receive from payment terminal 606 a transaction approval request 628 along with a token 609, payment terminal data, and additional data 611 obtained by payment terminal 606. For example, the additional data 611 may include a product price, a product ID, discounts, store data, advertisements, coupons, sales and the like.

In some demonstrative embodiments, the additional data (611) may be obtained by the payment terminal (606) and may include a product identification (ID) in relation to which the transaction is to be performed (610).

In some demonstrative embodiments, payment server 620 may further receive from the at least one payment account 616 an available balance 625 of said at least one payment account 616 and may generate a balance limitation decision being selected from: an approval, a partial approval, and a decline of the transaction approval request 628 based on the receive balance 625. Payment server 620 may send a request for mobile device data (line 612) to mobile device 613 and may receive mobile device data 630. For example, the mobile device data 630 may include location data, digital-wallet related data, mobile device number, user email address, and the like.

In some demonstrative embodiments, payment server 620 may generate a transaction approval decision (line 608) by cross-referencing the two or more sets of rules 607 with the mobile device data 630, the payment terminal data, additional data 611, and the balance limitation decision.

In some demonstrative embodiments, the trusted entities may include a loyalty club 602 that may manage a payment account 616 of the loyalty club member. For example, the payment account may include loyalty club points, a currency, a loyalty club currency, and the like. For example, the loyalty club 602 may generate a set of rules 607 for its member account and may provide the set of rules 607 to payment server 620.

In some demonstrative embodiments, the trusted entities may include a plurality of credit card companies 603 that may manage a payment account 616 of the plurality of credit card companies 603. For example, the payment account may include a currency, cryptographic coins, points, and the like. For example, the plurality of credit card companies 603 may generate a set of rules 607 for its client account and may provide the set of rules 607 to payment server 620.

In some demonstrative embodiments, the trusted entities may include a plurality of banks 604 that may manage a payment account 616 for a plurality of clients. For example, the payment account may include a currency, cryptographic coins, and the like. For example, the plurality of banks 604 may generate a set of rules 607 for its client account and may provide the set of rules 607 to payment server 620.

In some demonstrative embodiments, the trusted entities may include a plurality of credit card companies 603 that may manage a payment account 616 of the plurality of credit card companies 603. For example, the payment account may include a currency, cryptographic coins, points, and the like. For example, the plurality of credit card companies 603 may generate a set of rules 607 for its client account and may provide the set of rules 607 to payment server 620.

In some demonstrative embodiments, the trusted entities may include a plurality of other entities 605 that may manage a payment account 616 of the plurality users. For example, the payment account may include a currency, cryptographic coins, points, and the like. For example, the plurality of other entities 616 may generate a set of rules 607 for its users account and may provide the set of rules 607 to payment server 620. For example, the other entities may include an insurance company, a loans bank, a mortgage bank, an investment company, a financial company, and any other companies.

In some demonstrative embodiments, the payment accounts 616 may be configured to provide an account balance 625 to the payment server 620.

In some demonstrative embodiments, mobile device 613 may include a cellphone, a smartphone, a laptop computer, a tablet, a digital smartwatch, e.g., Apple Watch, and the like.

In some demonstrative embodiments, the payment server 620 may be configured to issue payment cards, such as us, for example, EMV credit cards, debit cards, loyalty club cards, and the like. Payment server 620 may hold user accounts, e.g., bank accounts, which may be connected to personal accounts of users of the payment server 620. Furthermore, payment server 620 may be configured to pay from a plurality of users personal accounts. For example, the payment server 620 may provide direct payments for goods and services purchased at a point of sale (POS) and charge the personal accounts of the users according to a predetermined schedule, e.g., once a month.

In some demonstrative embodiments, the payment card and/or the payment token which have been issued by payment server 620 may be used to pay for all the user personal accounts that are connected to the payment server according to the set of rules 607.

In some demonstrative embodiments, the mobile device data 630 may include a history log 614 which may be configured to store historical events data recorded by the mobile device 613.

For example, the mobile device data 630 may include data obtained in real-time from at least one of a plurality of input elements 615 which are operably coupled to the mobile device 609, wherein the plurality of the input elements may include, for example, a camera, a microphone, a touchscreen, an internal movement sensors, a scent sensor, a fingerprint reader, a global positioning system (GPS) receiver and the like

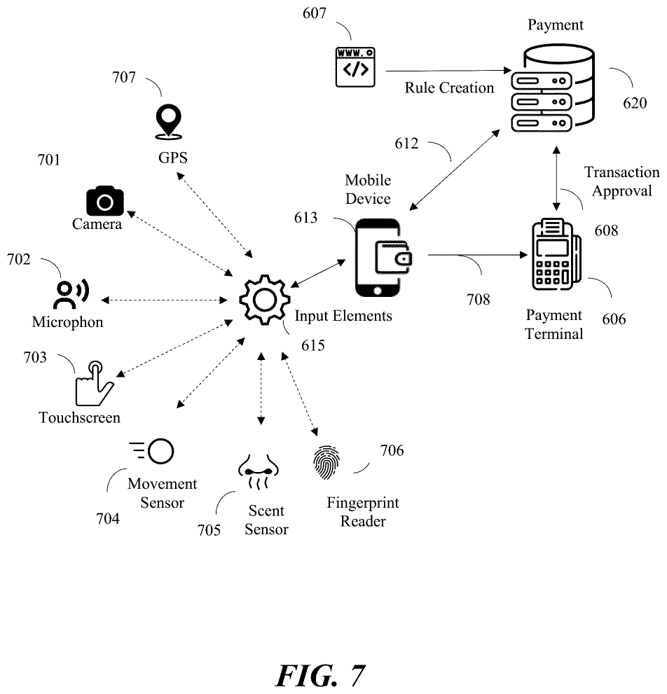

Reference is now made to FIG. 7 which illustrates the payment system 600 and a plurality of input elements configured to be controlled by a rule to interact with a user, according to some demonstrative embodiments.

In some demonstrative embodiments, payment system 600 may include a payment terminal 506, mobile device 613, e.g., a smartphone, a rule server 607, and an input elements controller 615. For example, the input element controller 615 may be operably coupled to a plurality of sensors, e.g., a camera 701, a microphone 702, a touch screen 703, an internal movement sensor 704, a scent sensor 705, a fingerprint sensor 706, a global positioning system (GPS) receiver 707, and/or any other sensor.

In some demonstrative embodiments, the mobile device data (FIG. 1, 630) may include data obtained in a real-time from at least one of a plurality of input elements which may be operably coupled to the mobile device 613. For example, the plurality of the input elements may include, but is not limited to: a camera 701, a microphone 702, a touchscreen 703, a movement sensor 704, a scent sensor 705, a fingerprint reader 706, and a GPS receiver 707.

In some demonstrative embodiments, system 700 may be configured to approve or decline a payment based on a rule that requests a payer to authenticate a request for payment done by a payment token (FIG. 6, 609) at a payment terminal 606 by providing a requested input as described below with the following examples.

In some demonstrative embodiments, mobile device 613, e.g., a smartphone, may send a request to pay for a product and/or service by providing a payment token (line 708) to payment terminal 606. The payment terminal 606 may request an approval for the payment from rule server 607.

In some demonstrative embodiments, rule server 607 may include a set of rules for a user and may approve and/or decline the payment based on one or more sets of rules. For example, a rule may include a request for the voice signature of the payer. The rule server 607 may send a request (line 612) to mobile device 613 to ask the payer to talk to microphone 702. The payer may provide his voice signature to the input element controller 615 (all dotted lines). The input devices controller 615 may send the voice signature of the payer to rule server 604 through mobile device 613.

In some demonstrative embodiments, rule server 607 may compare the voice signature of the payer with a stored voice signature of the payment token holder and may approve or decline the payment based on the comparison. For example, if the voice signature of the payer matched the stored voice signature, the rule server may approve the payment and may send the payment, to payment terminal 606 (line 708).

In some demonstrative embodiments, the described above method of approval may be implemented in a similar way for face recognition, e.g., by using camera 701, smell signature, e.g., scent sensor 705, motion recognition, e.g., recognizing a gesture using movement sensor 704, a request to press on a bottom or on a requested number, e.g., touchscreen 703, a request to read a fingerprint of the payer, and/or any other interaction with the payer and/or the cardholder.

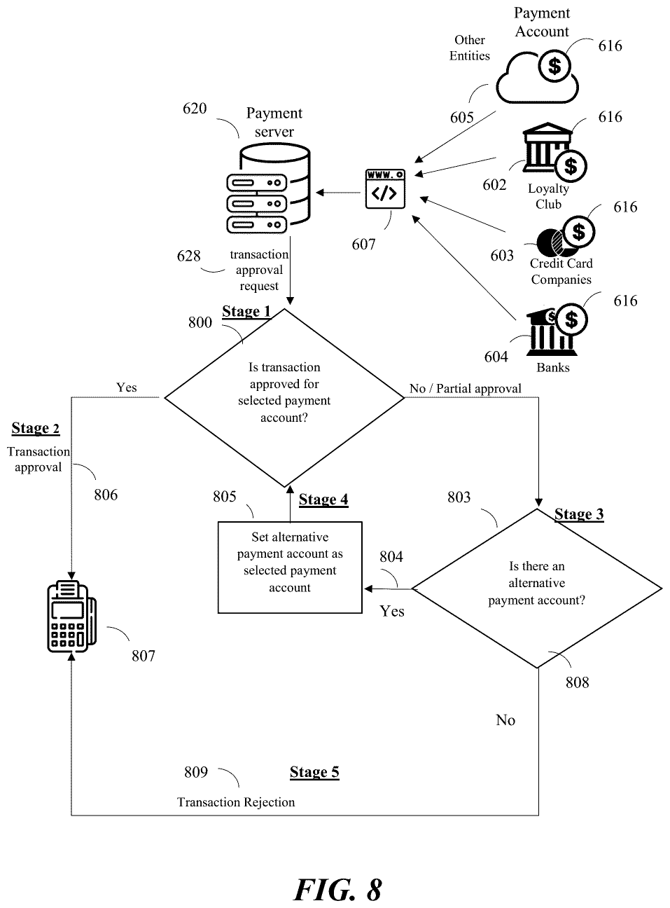

Reference is now made to FIG. 8 which illustrates a payment system and a flow chart of a method for payment 800, according to some other demonstrative embodiments.

Reference is now made to FIG. 8 which illustrates a payment system and a flow chart of a method for payment, according to some other demonstrative embodiments.

In some demonstrative embodiment, the method of payment will be described on system 600 of FIG. 6.

In some demonstrative embodiments, the method for the approval of the user transaction by the payment server 620 may include the following stages. For example, at stage 1, the payment server 620 may receive a transaction approval request 821 and may check whether the transaction approval request may be in a condition to be approved or partially approved for payment (Diamond 800) from a selected payment account of the one or more payments accounts 616 in accordance with two or more rules 607 of the trusted entity of 602, 603, 604, 605 of the two or more trusted entities associated with the selected payment account and a balance limitation decision for the selected payment account.

For example, if the transaction approval request is approved (“Yes”) the method may proceed to stage 2. If the transaction approval request is declined (“No”) the method may proceed to stage 3. If the transaction approval request is partially approved, payment server 620 may set a payable amount by the selected payment account as pending approval subject to an approval of a remaining amount for payment by another account selected from the two or more payment accounts, and the method may be configured to proceed to stage 3 in respect to the remaining amount.

In some demonstrative embodiments, at stage 2 the method may perform a transaction of a requested payment (806) via the payment terminal (807) to the selected payment account, e.g., payment account 616, of the one or more payment accounts 602, e.g., loyalty club 602.

In some demonstrative embodiments, at stage 3, the payment server 620 may check whether an alternative payment account is available (diamond 803), e.g., payment account 616 at bank 604. For example, if “Yes” (line 804) the method may proceed to stage 4, and if “No” (line 808), the method may proceed to stage 5.

In some demonstrative embodiments, at stage 4, payment server 620 may set the alternative payment account, e.g., payment account 616 at bank 604, as the selected payment account for paying the requested amount and/or a partial amount of the remaining amount of the transaction approval payment request. For example, the method may be configured to proceed to stage 1 in respect to the approval of the requested amount or the partially remaining amount of the two or more trusted entities (602, 603, 604, 605).

For example, at stage 5, if the transaction approval request in stage 3 is declined by all of said at least one other payment account (diamond 808), payment server 620 may decline the transaction (line 809) via the payment terminal (807).

In other demonstrative embodiments, payment server 620 may be configured to approve a user transaction. For example, the payment server 620 may check whether the transaction approval request (diamond 800) is in a condition to be approved or partially approved for payment from a selected payment account, e.g., payment account 616, of the one or more payments accounts, e.g., a credit card company 603, based on the two or more rules 607 of the trusted entity, e.g., credit card company 603, of the two or more trusted entities, e.g., trusted entities 602, 603, 604, 605, associated with the selected payment account, e.g., payment account 616 of credit card company 603, and a balance limitation decision for the selected payment account. Payment server 620 may perform a transaction of a requested payment (line 806) via the payment terminal 807 to the selected payment account 616 of the one or more payment accounts, e.g., credit card company 603, and may set the alternative payment account as the selected payment account for paying the requested amount or a partial amount of the remaining amount of the transaction approval request and may repeat the check, the perform and the set operations with respect to the approval of the requested amount or the partially remaining amount of the two or more trusted entities.

In this embodiment, when checking whether the transaction approval request is in a condition to be approved or partially approved for payment from the selected payment account of the one or more payments accounts, e.g., payment account 616 of credit card company 603 failed, and transaction approval request is declined (“No” of diamond 800), the payment server 620 may set the alternative payment account as the selected payment account.

Furthermore, when the transaction approval request is partially approved, the payment server 620 is configured to set the payable amount by the selected payment account as pending approval, subject to approval of a remaining amount for payment by another account selected from the two or more payment accounts, and may set the alternative payment account, e.g., account 616 of bank 604, as the selected payment account for paying for the remaining amount for payment.

In another scenario, when the alternative payment account is available (diamond 803) for payment, the payment server may set the alternative payment account, e.g., payment account 616 of credit card company 603, as the selected payment account for paying the requested amount or a partial amount of the remaining amount of the payment request. The payment server 620 may decline the transaction (line 809) via the payment terminal (807) when the alternative payment account is not available (803) for payment. For example, when the payment request is declined by all of said at least one other payment account (808), decline transaction (809) via the payment terminal (807).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts, or combinations of specialized purpose hardware and computer instructions.

The terminology used herein is to describe particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein are for the purpose of description and should not be regarded as limiting. The use of “including,” “comprising,” or “having,” “containing,” “involving,” and variations thereof herein is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

### EXAMPLES

The following examples pertain to further embodiments.

Example 1 includes a payment server configured to execute payments, the payment server comprising: a payment approval module configured to: receive a request for payment from a payment terminal by a digital payment token, wherein the digital payment token is not associated with a physical payment card; process the payment request according to a dynamic set of rules, wherein a set of rules of the dynamic set of rules is generated by a trusted entity and the set of rules comprises a plurality of Boolean rules which are validated and provided as a script and wherein the dynamic set of rules is continuously modified by a set of rules provider; and send an approval or denial of the payment request based on the processing of the payment request according to the dynamic set of rules.

Example 2 includes the subject matter of Example 1, and optionally, wherein the payment approval module is configured to receive the request for payment from a payment application embedded on a web page.

Example 3 includes the subject matter of Example 1, wherein the trusted entity is configured to receive an indication on activation of a rule of the dynamic set of rules.

Example 4 includes the subject matter of Example 1, wherein the payment approval module is configured to report to a buyer that the request for payment is refused based on an activation of a rule of the dynamic set of rules.

Example 5 includes the subject matter of Example 4, wherein reporting to the buyer comprises sending at least one of an email or a digital message to the buyer.

Example 6 includes the subject matter of Example 1, wherein an activation of a rule of the dynamic set of rules triggers an activation of another rule.

Example 7 includes the subject matter of Example 1, wherein the trusted entity is an entity that is verified by the payment server according to the set of rules and marked as trusted.

Example 8 includes the subject matter of Example 1, wherein the digital payment token comprises: user data arranged according to a Europay, Visa, Mastercard (EVM) standard.

Example 9 includes the subject matter of Example 1, wherein the digital payment token is uploaded with a zero number of benefits.

Example 10 includes the subject matter of Example 1, wherein the digital payment token is a one-time use token.

Example 11 includes the subject matter of Example 1, wherein a lifetime of the digital payment token is limited to a predetermined time.

Example 12 includes the subject matter of Example 1, wherein the dynamic set of rules comprises: a first set of rules provided by the payment server; a second set of rules is provided by the business group; a third set of rules is provided by a payment cards server; and a fourth set of rules is provided by one or more clients of the business group.

Example 13 includes the subject matter of Example 12, wherein a rule of the dynamic set of rules comprises a Boolean script which is configured to be executed by the payment server.

Example 14 includes the subject matter of Example 1, wherein the digital payment token is embedded in a software development kit (SDK) of a digital wallet, and the payment terminal is configured to receive the digital payment token from a mobile device that comprises the SDK.

Example 15 includes the subject matter of Example 14, wherein the SDK comprises the digital wallet application.

Example 16 includes the subject matter of Example 1, wherein the payment server, comprises: one or more databases of one or more business groups and a database of a business group comprising one or more clients; an issuer module configured to issue a digital payment token for each user of the client; and a payment module configured to transfer the requested amount of benefit to a merchant account and to update the user account and the client account.

Example 17 includes the subject matter of Example 1, wherein the payment server is configured to transfer payments to a payment network.

Example 18 includes the subject matter of Example 1, wherein the payment server is configured to receive payment from the business group every predetermined time for purchases made by the one or more clients.

Example 19 includes the subject matter of Example 1, wherein the payment server is configured to receive payment from a payment network every predetermined time for purchases made by the one or more clients.

Example 20 includes a product comprising one or more tangible computer-readable non-transitory storage media comprising program instructions for making payments with a payment program, wherein execution of the program instructions of the payment program by processing circuitry results in: receiving a request for payment from a payment terminal by a digital payment token, wherein the digital payment is not associated with a physical payment card; processing the payment request according to a dynamic set of rules, wherein a set of rules of the dynamic set of rules is generated by a trusted entity and the set of rules comprises a plurality of Boolean rules which are validated and provided as a script and wherein the dynamic set of rules is continuously modified by a set of rules provider; and sending an approval or denial of the payment request based on the processing of the payment request according to the dynamic set of rules.

Example 21 includes the subject matter of Example 20, wherein execution of the program instructions of the payment program by the processing circuitry results in: receiving the request for payment from a payment application is embedded on a web page.

Example 22 includes the subject matter of Example 20, wherein the trusted entity is configured to receive an indication on activation of a rule of the dynamic set of rules.

Example 23 includes the subject matter of Example 20, wherein execution of the program instructions of the payment program by the processing circuitry results in: reporting to a buyer that the request for payment is refused based on activation of a rule of the dynamic set of rules.

Example 24 includes the subject matter of Example 20, wherein reporting to the buyer comprises the execution of the program instructions of the payment program by the processing circuitry that results in sending at least one of an email or a digital message to the buyer.

Example 25 includes the subject matter of Example 20, wherein execution of the program instructions of the payment program by the processing circuitry results in: activating a rule of the dynamic set of rules that triggers an activation of another rule.

Example 26 includes the subject matter of Example 20, wherein the trusted entity is an entity that is verified by the payment server according to the set of rules and marked as trusted.

Example 27 includes the subject matter of Example 20, wherein the digital payment token comprises: user data arranged according to a Europay, Visa, Mastercard (EVM) standard.

Example 28 includes the subject matter of Example 20, wherein the digital payment token is uploaded with a zero number of benefits.

Example 29 includes the subject matter of Example 20, wherein the dynamic set of rules comprises: a first set of rules provided by the payment server; a second set of rules is provided by a business group; a third set of rules is provided by a payment cards server; and a fourth set of rules is provided by a client of the business group.

Example 30 includes the subject matter of Example 20, wherein a rule of the dynamic set of rules comprises a Boolean script which is configured to be executed by the payment server.

Example 31 includes the subject matter of Example 20, wherein execution of the program instructions of the payment program by processing circuitry results in: transferring the requested amount of benefit to a merchant account and updating the business group account and the client account.

Example 32 includes the subject matter of Example 20, wherein execution of the program instructions of the payment program by processing circuitry results in:
receiving payment from a client every predetermined time for purchases made by one or more users of the client.

Example 32 includes the subject matter of Example 20, wherein execution of the program instructions of the payment program by processing circuitry results in: receiving payment from a payment network every predetermined time for purchases made by one or more users of the client.

Example 33 includes a payment terminal configured to execute payments, the payment terminal comprises processing circuitry, wherein the processing circuitry is configured to: enable a token reader configured to receive a request for payment by a digital payment token transmitted by a payment application; enable a communication unit to transfer payer identification data and payer account data to a payment server for processing the payment request according to a dynamic set of rules, wherein a set of rules of the dynamic set of rules is generated by a trusted entity and the set of rules comprises a plurality of Boolean rules which are validated and provided as a script to a payment server, and wherein the dynamic set of rules is continuously modified by the set of rules provider; receive from the payment server approval or denial to the payment request based on the processing of the request of payment by a payment server based on the dynamic set of rules, and present by an interacting unit the process of approval.

Example 34 includes the subject matter of Example 33, wherein the payment application is embedded on a web page.

Example 35 includes the subject matter of Example 33, wherein the trusted entity is configured to receive an indication on activation of a rule of the dynamic set of rules.

Example 36 includes the subject matter of Example 33, wherein reporting to a buyer that the request for payment is refused based on activation of a rule of the dynamic set of rules.

Example 37 includes the subject matter of Example 36, wherein reporting to a buyer comprises sending at least one of an email or a digital message to the buyer.

The payment terminal of claim 1, wherein activation of a rule of the dynamic set of rules triggers activation of another rule.

Example 38 includes the subject matter of Example 33, wherein the digital payment token is not associated with a physical payment card.

Example 39 includes the subject matter of Example 33, wherein the trusted entity is an entity that is verified by the payment server according to the set of rules and marked as trusted.

Example 40 includes the subject matter of Example 33, wherein the digital payment token comprises: user data arranged according to a Europay, Visa, Mastercard (EVM) standard.

Example 41 includes the subject matter of Example 33, wherein the digital payment token is uploaded with a zero amount of benefits.

Example 42 includes the subject matter of Example 33, wherein the digital payment token is a one-time use token.

Example 43 includes the subject matter of Example 33, wherein a lifetime of the digital payment token is limited to a predetermined time.

Example 44 includes the subject matter of Example 33, wherein the dynamic set of rules comprises: a first set of rules provided by the payment server, a second set of rules provided by a business group, a third set of rules provided by a payment token issuer, and a fourth set of rules provided by the client of the business group.

Example 45 includes the subject matter of Example 33, wherein a rule of the dynamic set of rules comprises a Boolean script which is configured to be executed by the payment server.

Example 46 includes the subject matter of Example 33, wherein the digital payment token is embedded in a software development kit (SDK) of a digital wallet application, and the payment terminal is configured to receive data of the digital payment token from a mobile device that comprises the SDK.

Example 47 includes the subject matter of Example 46, wherein the SDK comprises the digital wallet application.

Example 48 includes the subject matter of Example 33, wherein the payment server comprises: one or more databases of one or more business groups and a database of a business group comprising one or more clients, an issuer module configured to issue a digital payment token for each client of the one or more clients, and a payment module configured to transfer the requested amount of benefit to a merchant account and to update the business group account and a client account.

Example 49 includes the subject matter of Example 33, wherein the payment server comprises: a payment module configured to transfer the requested amount of benefit to a payment network and to update the business group account and a client account.

Example 50 includes the subject matter of Example 33, wherein the payment server is configured to receive payment from a business group every predetermined time for purchases made by the one or more clients.

Example 51 includes the subject matter of Example 33, wherein the payment server is configured to receive payment from a payment network every predetermined time for purchases made by the one or more clients.

Example 52 includes a payment server operably coupled to two or more trusted entities and to a payment terminal wherein the payment server is configured to:
receive a request for payment from a payment terminal and a digital payment token comprising user data from a mobile device to authenticate the request for payment, process the request for payment according to a dynamic set of rules provided by the two or more trusted entities, wherein the dynamic set of rules are generated by the two or more entities and comprises a plurality of Boolean rules which are validated and provided as a script to the payment server, provide an approval or a denial of the request for payment to the payment terminal based on the dynamic set of rules of a selected trusted entity of the two or more trusted entities, wherein the selected trusted entity is operably coupled to a payment account, and when the request of payment is approved, provide a payment from one or more payment account connected to the two or more trusted entities according to the dynamic set of rules.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

What is claimed is:

1. A payment server for a user transaction approval (620) in communication with two or more trusted entities (601, 602, 603, 604, 605), at least one payment account (616) associated with a trusted entity of the two or more trusted entities, a payment terminal (606) and a mobile device (613), wherein the payment server is configured to:
receive from the two or more trusted entities two or more sets of rules for the user transaction approval (607);
receive from the payment terminal a transaction approval request (628) along with a token (609), payment terminal data, and additional data (611) obtained by the payment terminal (606);
receive from the at least one payment account (616) an available balance (625) and generate a balance limitation decision being selected from: an approval, a partial approval, and a decline of the transaction approval request based on the available balance;
send a request for mobile device data (612) from the mobile device (613) and receive the mobile device data (612);
generate a transaction approval decision (608) by cross-referencing the two or more sets of rules (607) with the mobile device data (630), the payment terminal data, the additional data (611), and the balance limitation decision.

2. The payment server of claim 1, wherein the mobile device data (630) comprise a history log (614) which is configured to store historical events data recorded by the mobile device.

3. The payment server of claim 1, wherein the mobile device data (630) comprise data obtained in a real-time from at least one of a plurality of input elements (615) which are operably coupled to the mobile device (613), wherein the plurality of the input elements comprise: a camera (701), a microphone (702), a touchscreen (703), an internal movement sensors (704), a scent sensor (705), a fingerprint reader (706) and a global positioning system (GPS) receiver (707).

4. The payment server of claim 1, wherein a method for the approval of the user transaction by the payment server comprises the following stages:
at stage 1 (800) check whether the transaction approval request (628) is in a condition to be approved or partially approved for payment from a selected payment account of the one or more payments accounts (616) in accordance with two or more rules (607) of the trusted entity (602, 603, 604, 605) of the two or more trusted entities associated with the selected payment account and a balance limitation decision for the selected payment account;
if the transaction approval request is approved (“Yes”) the method proceeds to stage 2;
if the transaction approval request is declined (“No”) the method proceeds to stage 3;
if the transaction approval request is partially approved, set a payable amount by the selected payment account as pending approval subject to an approval of a remaining amount for payment by another payment account or payment accounts selected payment account from the two or more payment accounts, and proceed to stage 3 in respect to the remaining amount;
at stage 2 perform a transaction in the amount of the transaction approval request (806) via the payment terminal (807) with the selected payment account or multiple selected payment accounts of the one or more payment accounts;
at stage 3 check whether an alternative payment account is available (803); if yes (804) proceed to stage 4 and if no (808) proceed to stage 5;
at stage 4 set the alternative payment account as the selected payment account for paying the full amount or the remaining amount of the transaction approval request, and proceed to stage 1 in respect to the approval off the full amount or the remaining amount of the transaction approval request; and
at stage 5, if the payment request in stage 3 is declined by all of said at least one other payment account (808), decline the transaction (809) via the payment terminal (807).

5. The payment server of claim 1, wherein the additional data (611) obtained by the payment terminal (606) comprise a product identification (ID) in relation to which the transaction is to be performed (610).

6. The payment server of claim 1, wherein a method for the approval of the user transaction by the payment server comprising:
checking whether the transaction approval request (800) is in a condition to be approved or partially approved for payment from a selected payment account of the one or more payments accounts (616) based on the two or more rules (607) of the trusted entity of (602, 603, 604, 605) of the two or more trusted entities associated with the selected payment account and a balance limitation decision for the selected payment account;
performing a transaction of a requested payment amount (806) via the payment terminal (807) to the selected payment account of the one or more payment accounts; and
setting the alternative payment account as the selected payment account for paying the requested payment amount or a partial payment amount of the remaining payment amount of the requested payment amount and repeating the checking, the performing and the setting with respect to the approval of the requested payment amount or the partially remaining payment amount of the two or more trusted entities.

7. The payment server of claim 6, wherein when checking whether the transaction approval request (800) is in a condition to be approved or partially approved for payment from the selected payment account of the one or more payments accounts is failed, and the payment request is declined (802), setting the alternative payment account as the selected payment account.

8. The payment server of claim 6, wherein when the payment request is partially approved, the method is configured to set the payable amount by the selected payment account as pending to approval, subject to approval of a remaining amount for payment by another account selected from the two or more payment accounts and setting the alternative payment account as the selected payment account for paying for the remaining amount for payment.

9. The payment server of claim 6, wherein when the alternative payment account is available (803) for payment, setting the alternative payment account as the selected payment account for paying the requested amount or a partial amount of the remaining amount of the payment request.

10. The payment server of claim 6, wherein when the alternative payment account is not available (803) for payment, decline transaction (809) via the payment terminal (807).

11. The payment server of claim 6, wherein the method comprises:
declining the transaction (809) via the payment terminal (807 when the payment request is declined by all of said at least one other payment account (808).

12. The payment server of claim 1, wherein the trusted entity of the two or more trusted entities is configured to receive an indication on activation of a rule of the two or more rules.

13. The payment server of claim 1, is configured to report to the mobile device that the request for payment is declined based on an activation of a rule of the one or more sets of rules.

14. The payment server of claim 1, wherein the activation of a rule of the sets of rules triggers an activation of another rule.

15. The payment server of claim 1, wherein the token is not associated with a physical payment card.

16. The payment terminal of claim 1, wherein the token comprises:
user data arranged according to a Europay, Visa, Mastercard (EVM) standard.

17. The payment terminal of claim 1, wherein the token is a one-time use token and uploaded with a zero amount of benefits.

18. The payment server of claim 1, wherein the token is embedded in a software development kit (SDK) of a digital wallet application, and the payment terminal is configured to receive data of the digital payment token from a mobile device that comprises the SDK.

19. The payment terminal of claim 19, wherein the SDK comprises the digital wallet application.

20. The payment server of claim 1, wherein the trusted entity is an entity that is verified by the payment server according to the set of rules and marked as trusted.

21. The payment server of claim 1, wherein the two or more set of rules comprises:
a first set of rules provided by the payment server;
a second set of rules provided by a business group;
a third set of rules provided by a payment token issuer; and
a fourth set of rules provided by the client of the business group.
